(19) United States
(12) Patent Application Publication
(10) Pub. No.: US 2018/0093373 A1
(43) Pub. Date: Apr. 5, 2018

(54) Concrete Printer and Method for Erecting Structures Using a Concrete Printer

(71) Applicant: Imprimere AG, Oberdorf (CH)

(72) Inventor: Anton Niederberger, Oberdorf (CH)

(21) Appl. No.: 15/565,906

(22) PCT Filed: Apr. 12, 2016
(86) PCT No.: PCT/EP2016/058041

§ 371 Date: Oct. 12, 2017

(30) Foreign Application Priority Data
Apr. 12, 2015 (DE) 10 2015 105 554.6

(51) Int. Cl. B25J 5/04; B25J 9/00; B25J 9/02; B28B 1/00; B28B 3/20; E04G 21/04

(52) U.S. Cl. CPC B25J 5/04; B25J 9/0087; B25J 9/026; E04B 1/3505; B28B 3/20; E04G 21/04; B28B 1/001

(57) ABSTRACT

The aim of the invention is to provide a concrete printer which allows complex concrete elements and structures to be erected within a short time with the inclusion of a reinforcement and surfacing process. The concrete printer according to the invention, in particular for producing concrete elements and structures, has a vertically (Z) movable jack lift (6) which can be moved on two perpendicular rails (3) by a first drive unit (5). The jack lift (6) is connected to a longitudinal crossbeam (7) oriented horizontally in the longitudinal direction (X), and the longitudinal crossbeam (7) is connected to two guide rails (8) oriented in the longitudinal direction (X). A transverse crossbeam (9) which is oriented perpendicularly to the longitudinal crossbeam (7) can be moved along the guide rails (8) by a second drive unit (10), and at least one working head (13) is provided which can be moved along the transverse crossbeam (9), comprises at least one concrete printing nozzle (11), and can be moved by a third drive unit (12). The actuation of all the drive units (4, 5, 10, 12) and the concrete printing nozzles (11, 11a, 11b) is carried out by a control unit (41). In the method according to the invention, supporting concrete (18) is first cast or dispensed from a supporting concrete nozzle (11a) for an outer contour (18) and/or an inner contour (18). Reinforcement rods (31) are then optionally inserted, and the intermediate spaces (47) between the supporting concrete portions (18) and optional reinforcement rods (31) are then cast with liquid concrete (19) from the liquid concrete nozzle (11b).

### CROSS REFERENCE TO RELATED APPLICATIONS

This application is the U.S. national stage of International Application No. PCT/EP2016/058041, filed on 2016 Apr. 2012. The international application claims the priority of DE 102015105554.6 filed on 2015 Apr. 12; all applications are incorporated by reference herein in their entirety.

### BACKGROUND

This invention regards a concrete printer that allows the formation of three-dimensional constructions.

The three-dimensional working concrete printer makes it possible to create constructions, such as concrete elements, through an application of concrete corresponding to a defined arrangement.

The concrete printer consists of two vertical guide rails on which a vertically moving lift truck is arranged with a second drive unit. On the lift truck, in turn, there are one or multiple cross bars designed as a framework construction. Two guide rails are arranged on the cross bars. One or multiple cross bars are arranged as a formed framework construction and at a right angle to the cross bar and can be moved with a second drive unit. A moving work head is arranged on the cross bar that at least includes one concrete printer nozzle. The moving of the work head is carried out through a correspondingly arranged third drive unit.

This ensures a concrete printer construction that allows for a movement of the work head with the concrete printer nozzles in three dimensions and therefore a spatial concrete printing. The movements of the work head to apply the concrete are performed through movements of the cross bar along the cross bar and the work head along the cross bar as well as through the change in height through the lift truck.

Concrete printers are known in different designs.

From the DE 10 2011 113 163 A1, there is a procedure and a device to produce a concrete component as well as a concrete component made according to the procedure.

### SUMMARY

The task of the invention is too provide a concrete printer that makes it possible to create complex concrete elements and constructions including reinforcement and surface processing in a short amount of time.

The concrete printer subject to invention, in particular for the production of concrete elements and constructions, has a lift truck (6) that can be moved vertically (Z) on two vertical tracks (3) with a first drive unit (5), whereby the lift truck (6) is connected with a horizontal longitudinal beam (7) oriented in a longitudinal direction (X). The longitudinal beam (7) is connected with two guide rails in the longitudinal direction (X), whereby a cross beam (9) oriented at a right angle to the longitudinal beam (7) can be moved along the guide rails (8) with a second drive unit (10) and at least has a moving work head (13) arranged along the cross beam (9) with a concrete printer nozzle (11) and can be moved through a third drive unit (12). The control of all drive units (4, 5, 10, 12) and the concrete printer nozzles (11, 11a, 11b) is performed through a control unit (41).

With this procedure subject to invention, initially supporting concrete (18) from a supporting concrete nozzle (11a) is initially cast or applied for an outer contour (18) and/or inner contour (18), then optionally reinforcing bars (31) are inserted and then the spaces (47) between the supporting concrete sections (18) and reinforcing bars (31) are cast with liquid concrete (19) from the liquid concrete nozzle (11b).

### DETAILED DESCRIPTION

The task of the invention is too provide a concrete printer that makes it possible to create complex concrete elements and constructions including reinforcement and surface processing in a short amount of time.

The invention shows that the task can be solved with the characteristics of the main claim.

The invention is regarding a concrete printer to produce concrete elements and constructions as well as a procedure to construct a corresponding concrete element and construction through the concrete printer.

The concrete printer includes of two vertical guide rails on which a vertically moving lift truck is arranged with a first drive unit. This allows the lift truck to change its height with the first drive unit. The lift truck in turn is connected with a cross beam oriented in the longitudinal direction.

Two guide rails oriented in the longitudinal direction are mounted on the cross beam on which a crossbeam is arranged oriented towards the cross beam at a right angle. The crossbar can therefore be moved along the guide rails through a second drive unit. On the crossbar, there must be a work head along that can be moved along the crossbar, has at least one concrete printer nozzle and can be moved through a third drive unit. The concrete printer nozzle is designated to apply concrete that has not yet been set. The consistency of the concrete may vary between liquid concrete and comparably hard concrete.

The concrete printer may create three-dimensional forms made of concrete or additional materials, such as reinforcements. In particular, the design is suitable for producing concrete elements. The concrete printer nozzle to apply concrete my be moved in three dimensions. This makes it possible to quickly and precisely position the concrete printer nozzles and therefore to apply concrete. The positioning of the printer nozzle is carried out together with the drive units, which are realirealiseed through a control through a control unit. The control unit is preferably designed to process correspondingly imported data such as the dimensions and the construction details of the building as well as the process for the production of construction elements. This allows the concrete printer to create corresponding constructions, in particular concrete elements, in an either fully or partially automated manner.

The assembly and disassembly of the concrete printer is mostly done on the ground due to the modular construction and is therefore possible in a short amount of time without much aid. Through the modular construction, the size of concrete printer can be adjusted to the size of the construction to be made.

Other advantageous designs of the invention are disclosed in the sub-claims.

In accordance with a further formation, the two vertical guide rails are arranged on a carriage,whereby the carriage is preferably arranged with the ability to move to the side on a rail laid in a horizontal direction through a fourth drive unit. The drive unit serves to move the carriage on to the rail corresponding to the requirements to get to the respective working spot. The control of the fourth drive unit is realised through the control unit so that a monitored and controlled procedure of the carriage is possible.

Through multiple carriages, the respective concrete printer can be positioned corresponding to the concrete elements to be created. The concrete printer can work alternating on multiple construction elements. Correspondingly, one construction element can be created while other construction elements harden. In this way, work procedures can be optimised with high machine utilisation.

Corresponding to the design of the invention, the cross bar and/or cross beam are designed as framework constructions, preferably as 3-belt or 4-belt framework constructions, whereby the framework constructions are preferably made of dummy elements made of fibre-reinforced plastics and with approximately ball-shaped nodes as connecting elements for example made of aluminium. The connection with each other is carried out, for example, through an insertion and/or bolting or through a bayonet catch. The construction permits a light construction of the concrete print over large spans. Thus, large concrete elements and also buildings can be created. The assembly, disassembly and transport of a concrete printer at construction sites is therefore possible without a lot of aids, such as cranes. Large spatial areas can be created through the construction and extensive contours printed, which cannot be realised in a conventional manner or only through extensively pre-fabricated forms.

In accordance with the formation of the invention, in particular the second, third and fourth drive unit are designed as spindle drives or toothed belt drive. Spindle drives and toothed belt drives allow for an exact positioning and guiding of the concrete printer nozzle and therefore a precise adjustment of the location for the precise production of the constructions.

Drive units with toothed belt drives allow for a quick positioning and guidance of the concrete printer nozzles and, if necessary, other work aggregates such as reinforcement grippers.

Corresponding to an advantageous design of the invention, the work head includes at least one support concrete nozzle to apply low-water supporting concrete and at least one liquid concrete nozzle to apply water-saturated liquid concrete. Through the possibility to apply supporting concrete and liquid concrete after each other or parallel to each other, different consistencies of concrete may be combined corresponding to the requirements of the construction. The supporting concrete is suitable for the assembly of outdoor areas from walls of the areas to be filled, because it can be applied in a comparably stable manner. The liquid concrete is in particular suitable for casting spaces in wall constructions, such as integrated reinforcements, or to realise the wall construction with forms. The different concrete print nozzles can be arranged on the work head next to each, after each other or offset.

In accordance with a further formation of the invention, the concrete printer nozzles are designed as mixed nozzles and/or switching nozzles. The nozzles from different concrete mixtures may be added when designed as switch nozzles. Through the addition of low-water concrete, the corresponding nozzle can act as a supporting concrete nozzle or work as a liquid concrete nozzle through the addition of liquid concrete. The switch equipment may be arranged in the nozzle or in the lines to the nozzle.

A design as a mixed nozzle is also possible. The mixture makes it possible to mix different added concrete mixtures. A mixture of water and different additional substances is possible, for example, to accelerate the setting. The nozzles can finally be used universally corresponding to the requirements.

At the same time, the switch nozzles may have a turret type design. It is therefore possible to switch between two or multiple different nozzle outlets that are different, for example, in the outlet cross sections.

Corresponding to a further formation of the invention, the work head includes at least a form pressure nozzle, a smoothing unit, a bursting unit, an embossing roller, a milling unit, a grinding unit, a reinforcement gripper, a welding unit and/or a suction unit.

The form pressure nozzle makes it possible to create a from made of plastic before the concrete print. A smoothing unit, such as in the form of a guide sheet on the side of the work head, for example, allows for a smoothing of the outer sides of the walls. The smoothing unit can also be designed as a flexible or rotating float and thereby allow for a smoothing of outer walls. A bursting unit makes it possible to cover outer walls with integrated water feed. A structuring of the wall surfaces is possible through this. Another possibility of structuring the wall surfaces exists in applying an embossing structure on the wall surfaces through an embossing roller arranged on the work head. A milling unit and/or a grinding unit allow for surface processing of the hardened outer walls as well as the removal of a previously printed form. Through a reinforcement gripper, the work head can grab reinforcing bars and position them correspondingly in the wall to be created. A welding unit makes it possible to weld reinforcing bars and therefore produce a corresponding reinforcement basket. The suction unit allows for a clean operation, which prevents excessive dust emissions. Furthermore, it is possible to bring removed, excessive concrete back into the pressure cycle and continue to use it. The individual aggregates can be combined individually or with each other corresponding to an advantageous design and arranged on different work heads. This makes it possible, for example, to apply concrete with a work head and to place or weld with a different reinforcing bar. A corresponding work head can be equipped with corresponding aggregates for surface processing.

In accordance with the further formation of the invention, the concrete printer includes a trimming unit and a bending unit arranged on the carriage. Furthermore, the concrete printer includes a transport unit for the reinforcing bars to move them in the working area of the reinforcement gripper. With the trimming unit, the reinforcement material provided as sticks or from a roll can be trimmed to the respectively required length. The bending unit makes it possible to bend the reinforcing bars corresponding to the requirements. After this, the reinforcing bars are moved vertically by a transport unit. After this, they are taken over by a reinforcement gripper and placed in the corresponding final position. Through the arrangement on the carriage, the aggregates designated for reinforcing bar production are moved along to the place of use.

Corresponding to an advantageous design of the invention, the concrete printer, preferably on the carriage, includes at least a concrete pump and/or a concrete mixing unit and/or at least a storage container for concrete and/or concrete additives. Through the concrete pump, the concrete mixing unit and the storage container, the provision and mixing of the concrete is integrated in the concrete printer. The material provision or concrete preparation is carried out on the ground and is therefore easily accessible for corresponding delivering vehicles. At the same time, the weight of the concrete or concrete substances increases the stability of the concrete printer. The supply of the concrete printer nozzles is carried out through corresponding hoses that allow for a flexible supply of the printer nozzles with material. Through the arrangement on the carriage, the aggregates designated for concrete preparation are moved along to the place of use.

In accordance with the further formation of the invention, the work head in a work head intake is stored with the ability of at least a vertical axis. With this design, it is possible to position, arrange and/or align the different concrete printer nozzles and/or form printer nozzles from a work head respectively corresponding to the alignment of the wall to be created. This design allows the concrete printer to react very flexibly to different requirements. If necessary, different nozzles may also be operated parallel to each other and therefore reduce the time needed to create the constructions.

Corresponding, it is also possible to move a smoothing unit, a bursting unit, an embossing roller, a milling unit and/or a grinding unit quickly to the corresponding work position and alignment if needed in addition to the concrete printer nozzles.

Through the flexible bearing, the work head can be aligned differently so that it is possible to work from above as well as from different sides.

Corresponding to a preferred design of the invention, the work head or aggregates of the work head are formed as multiple axis robots. The multiple axis robot is preferably designed as a 5-axis robot or a 6-axis robot. Multiple axis robots allow for a versatile positioning of the work head equipped with the printer nozzles and the other aggregates. The nearly free positioning is in regards to the final position of the printer nozzles or the other aggregates as well as their alignment. This makes it possible, for example, to apply concrete on the side as spray plaster on a wall. In regards to the positioning and alignment of the welding electrode, the welding robot is also free so that it is possible to perform side welding of the reinforcing bars. The multiple axis robots are particularly ideal for guiding the reinforcement gripper. This makes it possible to position reinforcing bars from all sides in the wall to be constructed in different locations.

Corresponding to a further formation of the concrete printer, the concrete printer nozzles are equipped with one, two or multiple individual and/or grouped controllable nozzle connections. Through the different nozzle connections, the concrete printer nozzles may be used for concrete with different moisture content and different variations of additives. This allows the concrete printer nozzles to act as supporting concrete nozzles and liquid concrete nozzles corresponding to the control of the nozzle connection and therefore the variation of the concrete feed. Furthermore, the nozzles may also be designed as mixed nozzles so that the concrete composition can be varied through the changing control of the different nozzle connections. This, it is also possible to apply different concrete mixtures from the respective concrete printer nozzles, which are added through the different nozzle connections. In addition to the concrete mixtures, water and additives, such as rapid hardener, can be added through the nozzle connections. This means there may also be a mixture of concrete mixtures or individual additives in the respective nozzle.

Corresponding to a design of the invention, the form nozzles must be arranged at least horizontally on the work head.

This makes it possible to establish the form from the side through the form nozzles. In this way, for example, the form may be applied on the side with a previously constructed reinforcement basket.

Furthermore, the invention task is solved through the provision of a procedure to produce construction elements through a concrete printer.

The procedure according to the invention designates that initially supporting concrete will be cast/applied from a supporting concrete nozzle, then optionally reinforcing bars will be inserted and thereafter the spaces between the supporting concrete sections and the reinforcing bars will be cast with liquid concrete from the liquid concrete nozzle. The procedure therefore requires the production of complete concrete walls including reinforcement. Both outer and inner contours of the construction elements are made of supporting concrete. These then create the form for filling with liquid concrete. Correspondingly created reinforcing bars can be optionally inserted before casting.

Corresponding to a further formation of the procedure, additional retaining elements can be printed or prefabricated retaining elements may be installed and placed through the reinforcement gripper of the concrete printer. The retaining elements may be made of or have been made of supporting concrete or other materials. The retaining elements serve as the support for the reinforcing bars. Recesses may be worked into the retaining elements, which allow for a fixing of the location of the reinforcing bars. The retaining elements may also be provided with a vertical blind hole. The blind hole makes it possible to insert vertical reinforced bars.

Corresponding to a further formation of the invention, the sequence of the production of the outer contour or the inner contour, the production or placement o f the retaining elements and the arrangement of reinforced bars as well as the application of liquid concrete are repeated in layers.

Through the layered structure, the next layer may be applied after the respective hardening or partial hardening and correspondingly achieved bearing capacity of the substructure.

An alternative procedure for the creation of a construction with a concrete printer realises that supporting concrete is applied around a basket made of reinforced bars through a supporting concrete nozzle and then the spaces between the supporting concrete sections are cast with liquid concrete from the liquid concrete nozzles. The supporting concrete then acts as a shell in which the liquid concrete is applied. The application of the liquid concrete may occur parallel to the application of the supporting concrete as well as after the hardening of the supporting concrete.

In accordance with a further formation of the procedure, the reinforced bars are cut to the required length in the trimming unit, bent into the defined form in the bending unit, moved into the required position in the construction with the transport unit and/or the reinforcement gripper.

The further formation of the procedure includes the welding of the reinforced bars designed as reinforced steel through the welding unit. The procedure according to the invention therefore make it possible to completely produce larger and complex reinforcement baskets by welding the reinforced bars.

A further formation of the procedure requires that a form be created for the supporting concrete and/or liquid concrete through a form nozzle. The form may be preferably made of plastic and/or with printer concrete. The form may be connected with the reinforcement baskets. However, if reinforcement steel is used it must be ensured that a corresponding concrete cover is realised to prevent corrosion of the reinforcement steel. If plastic is used, the form may be realised as a net-shaped supporting structure for the stabilisation of the more solid supporting concrete.

Corresponding to a further formation of the invention, the created wall surfaces are subject to a surface treatment of the external concrete layer through a smoothing unit, bursting unit, embosser roller, milling unit and/or grinding unit. The surface treatment may occur parallel to the application of the concrete or thereafter. The surface processing is performed during milling and/or grinding during and/or after the hardening of the concrete. Correspondingly, a removal of the form after the concrete hardens is also possible. Thus, the procedure in accordance with the invention includes all steps that are needed or feasible for the complete production of construction elements/constructions.

### BRIEF DESCRIPTION OF THE DRAWINGS

Advantageous execution examples of the invention are explained in detail based on drawings.

The following is shown:

FIG. 1 a perspective view of a concrete printer,

FIG. 2 a perspective view of the lift truck,

FIG. 3 a perspective view of the crossbar and cross beam with work head,

FIG. 4 a perspective view of the work head with a concrete printer nozzle and reinforcement gripper

FIG. 5 structure of a concrete element with supporting concrete,

FIG. 6 layered structure of a concrete element,

FIG. 7 structure of a reinforcement basket with optional form print,

FIG. 8 a concrete printer nozzle with a nozzle connection,

FIG. 9 a concrete printer nozzle with two nozzle connections,

FIG. 10 a concrete printer nozzle with two external nozzle connections,

FIG. 11 a turret-shaped concrete printer nozzle arrangement,

FIG. 12 a printer head with three adjacent concrete printer nozzles,

FIG. 13 a printer head with three concrete printer nozzles arranged in a ring,

FIG. 14 a supporting concrete nozzle with a float,

FIG. 15 a supporting concrete nozzle with a rotating float,

FIG. 16 a supporting concrete nozzle with a bursting unit,

FIG. 17 a supporting concrete nozzle with embosser roller

FIG. 18 an arrangement of reinforced bars and

FIG. 19 an arrangement of reinforced bars with retaining elements.

### DETAILED DESCRIPTION OF THE PREFERRED EMBODIMENTS

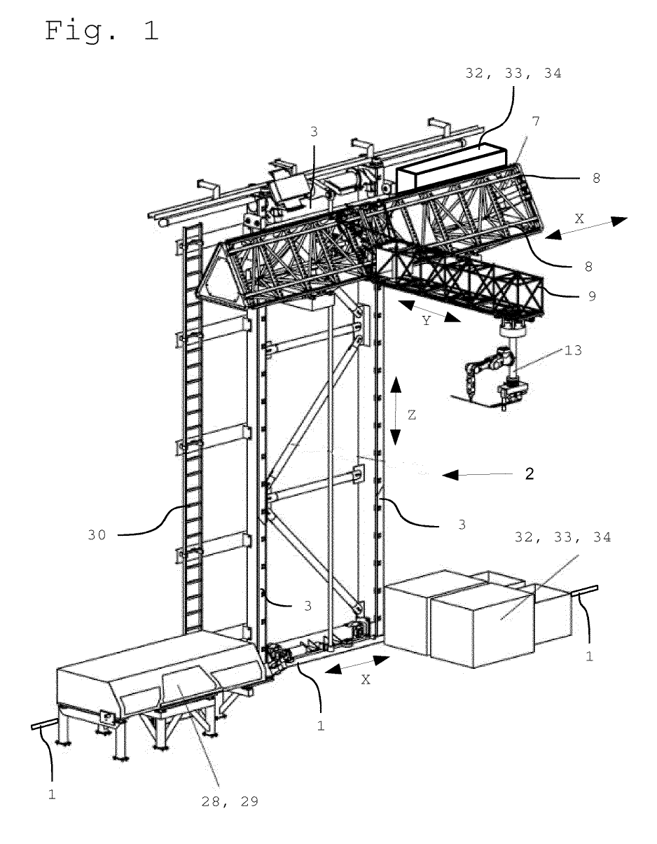

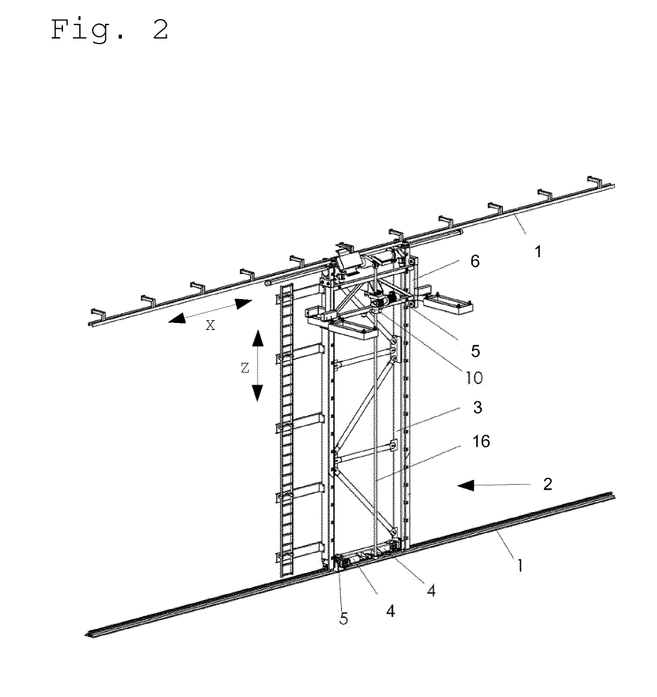

The FIGS. 1 to 3 show a concrete printer in a perspective view. FIG. 1 shows a perspective overall view of the concrete printer. In FIG. 2, the lift truck 6 is shown in more detail. FIG. 3 shows the cross bar 7 and cross beam 9 with a work head 13 in an enlarged illustration.

The illustrated concrete printer can be moved on a carriage 2 in the X-direction through a drive through a fourth drive unit 4 along a track 1. A lift truck 6 is arranged on the carriage 2 on the vertical rails 3 installed on the carriage 2.

The lift truck 6 can be changed in its height Z through a first drive unit 5 along the vertical track 3.

A cross beam 7 is arranged on the lift truck 6. The cross beam 7 is located parallel to the tracks 1 in the X-direction. Two guide rails 8—one on the top and one on the bottom—are mounted on the cross beam 7 in the X-direction. The cross bar 9 can be moved along these guide rails 8. A second drive unit 10, which works together with a toothed belt 17, is planned for this drive. Along the cross beam 9 oriented in the Y-direction, the work head 13 may be moved with a third drive unit 12 and a guide.

The drive units are electric motors that work together with a toothed belt 17 or a spindle drive 16. The spindle drive 16 may take on great strengths and is suitable for the lift ruck 6.

The toothed belt drive 17 allows for the execution of fast movements. Through the construction with lift truck 6, cross bar 7 and cross beam 9 as well as the drive units 4, 5, 10, 12, a free positioning of the work head 13 in the room is possible.

The movement of the concrete printer to the individual places of use is possible through the arrangement on a carriage 2 guided from a track 1 with the fourth drive unit 4. The tracks 1 may be laid in the shape of a ring as well. The concrete printer may also be designed as a track-independent vehicle that can move independently r be driven to the corresponding work sites in a hall or on a construction site, extends its supporting equipment and calibrates itself to realise the printing process. A trimming unit 28, a bending unit 29 and a transport unit 30 are arranged on the carriage 2. Reinforced bars 31 can be created correspondingly with this and moved into the work area of the reinforcement gripper 27 through the transport unit 30.

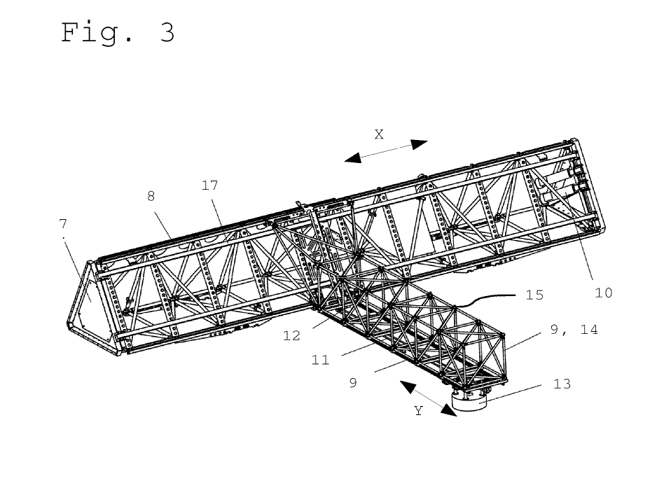

FIG. 4 shows a perspective view of the work head 13 with concrete printer nozzles 11a, 11b. The work head 13 is attached through a work head intake 35, which is found on the cross beam (not illustrated). The work head 13 consists of a printer head 46 with two side supporting concrete nozzles 11a, through which the supporting concrete (not illustrated) is transported and a liquid concrete nozzle 11b, through which the liquid concrete (not illustrated) is transported. A form printer nozzle 20 may also be arranged on the printer head 46, through which a form can be made of thermoplastic. The printer head 46 can be rotated 360° thanks to the motor-driven turning unit 45. The turning unit 45 allows for a rotation around a vertical axis 43 by, for example, 360 degrees. This makes it possible to have a very flexible positioning of the concrete printer nozzles 11a, 11b and the alignment to each other. Furthermore, a milling unit 24 is arranged on the printer head 46 here that allows for side surface processing.

The concrete printing nozzles 11a, 11b are equipped with nozzle connections 36 through which the concrete is fed through hoses (not illustrated). With multiple nozzle connections 36, if necessary, water and/or other additives may be added.

The form printing nozzle 20 is added thermally softening plastic. The form printing nozzle 20 is equipped with a cooling and/or heating unit for this purpose.

The work head 13 also includes a gripper 27, which is guided by a multiple axis robot 44. This makes it possible to executed diverse movements to pick up, align and position reinforced bars 31. With the gripper 27, form elements including affiliated supports as well as retaining elements that serve as a base for the reinforcer bars 31 can be positioned correspondingly.

Alternatively, the multiple axis robot 44 can be arranged with the gripper 27 on a separate work head 13. This makes the movements for printing and for placing the reinforcer bars 31 more independent of each other.

Just as with the gripper 27, a welding robot can be arranged on a work head 13 through the multiple axis robot 44.

In principle, it is intended for all aggregates to be able to be operated independent of each other. This makes it possible to activate individual aggregates, for example just the support concrete nozzle, as well as multiple aggregates, such as the gripper, welding robot and/or smoothing unit (all not illustrated), parallel to each other.

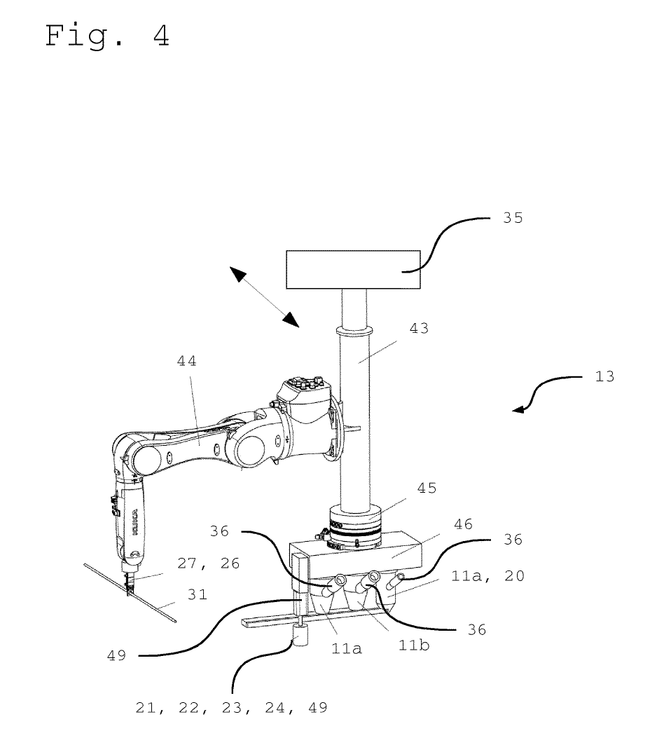

The FIG. 5 shows the structure of a concrete element with structures made of supporting concrete 18. The supporting concrete 18 is is applied in layers. Spaces 47 are filled by the supporting concrete 18. Through the reinforcement grippers 27, reinforcer bars 31 are placed in the spaces 47. In the following, the spaces 47 are filled with liquid concrete 19 from a liquid concrete nozzle (not illustrated).

FIG. 6 shows how a layered structure of a concrete element may be feasible using a concrete printer. Initially supporting concrete 18 is applied through the supporting concrete nozzle (not illustrated) to create an outer contour 18 and an inner contour 18. Retaining elements 42 made of supporting concrete 18 are also created in the same manner through the supporting concrete nozzles. The retaining elements 18 serve as a base for reinforcer bars 31. Through the corresponding arrangement of retaining elements 42, the reinforcer bars 31 may be installed in the concrete element corresponding to the reinforcement plan. Then they can be filled with liquid concrete (not illustrated). In the next step, the outer contours 18, the inner contour 18 and the retaining elements 42 are structured at a height so that the next layer of reinforcer bars 31 can be installed.

It is then followed again by a filling with liquid concrete. Concrete elements with reinforcement can be structured in this way. The filling with liquid concrete may optionally be executed at the end of the process. Vertical reinforcer bars (not illustrated) may be inserted in retaining elements 42 with vertical blind holes.

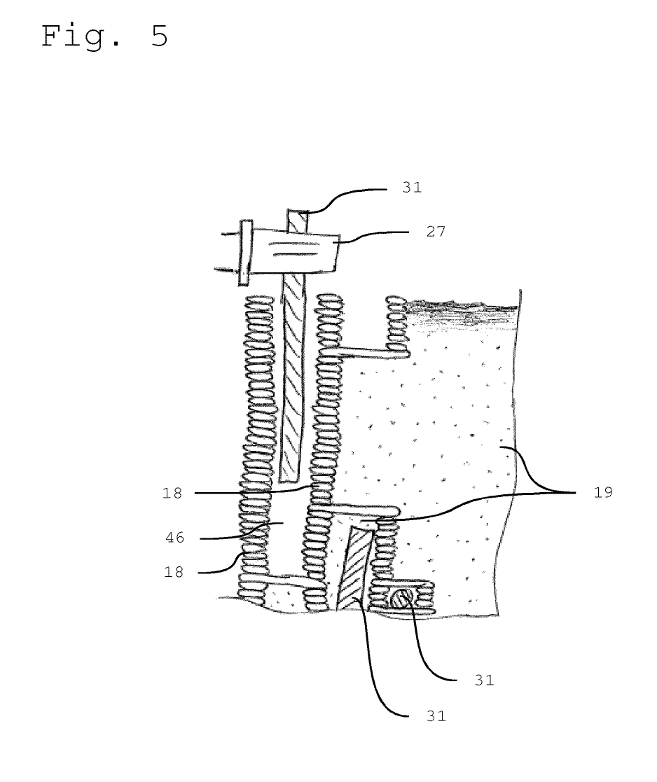

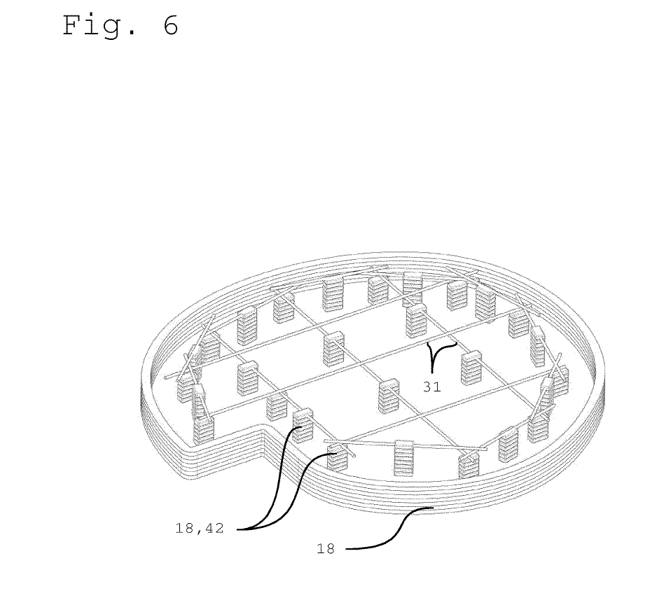

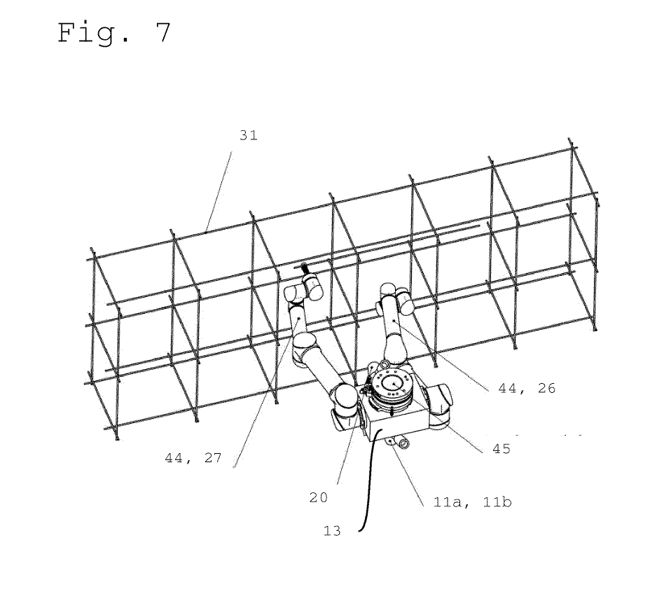

FIG. 7 shows the structure of a reinforcement basket with optional form printing. The structure of the reinforcement basket 31 made of reinforcer bars 31 is realised with a work head 13 mounted on a rotating unit 45. A reinforcement gripper 27, which is guided by a multiple axis robot 44 to place the reinforcer bars 31, is arranged on the work head 13. A welding unit 26 is arranged on another multiple axis robot 44. The welding unit 26 serves to weld the reinforcer bars 31 with each other.

Alternatively, a binding or clamping device may be arranged to connect the reinforcer bars 31 with each other. Through the multiple axis robot 44, the welding unit 26 and the reinforcement gripper 27 can be controlled independent of each other.

A form printing nozzle 20 is still arranged on the work head 13. The form printing nozzle 20 is designated for printing a form (not illustrated) that holds the concrete. The form may, for example, be structured as a wall made of thermoplastic. A net-shaped form may also be printed on the reinforcement basket 31.

Additionally, threads of plastic may be arranged correspondingly to connect the double-sided form walls through the form printer nozzle 20. Preferably thermoplastic is used as a form material. The form printing nozzle 20 is equipped with a cooling and/or heating unit for this purpose. Through the concrete printer nozzles 11a, 11b, the concrete is applied between the reinforcer bars 31 and, if necessary, the form net.

Instead of reinforcer bars 31 made of steel, reinforcer bars 31 made of other metals or plastics or similar materials such as carbon fibre may be used. It is also possible to make a construction as textile concrete. The reinforcement gripper 27 and other aggregates must then be designed so that they can position the threads or fabrics or knittings corresponding to the requirements. A reinforcement with plastic threads or carbon fibre threads may be executed by applying grains of sand on the liquid thermoplastic plastic. The same may be done correspondingly with the carbon fibre threads using bonding agents. This makes the surface of the respective threads rougher so that the fibres in or on the plastic and the grains of sand embedded in the concrete can better handle traction. The application of plastic threads or carbon fibre threads for reinforcement may occur correspondingly analogue to the form printer nozzle 20.

In FIG. 8, a concrete printer nozzle 11 with a side arranged nozzle connection 36 is illustrated. The nozzle connections are, for example, connected with hoses through fast couplings. The concrete is transported through the hoses using concrete pumps 32 from the concrete mixing unit 33 to the concrete printer nozzles 11.

FIG. 9 shows a concrete printer nozzle 11 with two nozzle connections 36. Through a switch found inside the nozzle, the concrete printer nozzle 11 can therefore act as a supporting concrete nozzle 11 a as well as a liquid concrete nozzle 11b. By mixing in the concrete printer nozzle 11, the concrete may be mixed with additives to harden faster or water to change the moisture of the concrete.

In FIG. 10, there is a concrete printer nozzle 11 with two external nozzle connections 36. In this way, a concrete printer nozzle 11 with a nozzle connection 36 can be equipped with two external nozzle connections 36 on a bivalent operation. In the nozzle connections 36, corresponding dosing units may exist for the controlled addition of concrete, water or additives. A corresponding mixing module to mix material may also be arranged in the concrete printer nozzle 11 or on the concrete printer nozzle 11.

FIG. 11 shows a turret-shaped printer head 46 with concrete printer nozzles 11a, 11b and corresponding nozzle connections 36 as well as a milling head 24. Through the rotation of the turret printer head 46, the liquid concrete nozzle 11b, the supporting concrete nozzle 11 a or the milling head 24 may be positioned as needed corresponding to the respective requirements.

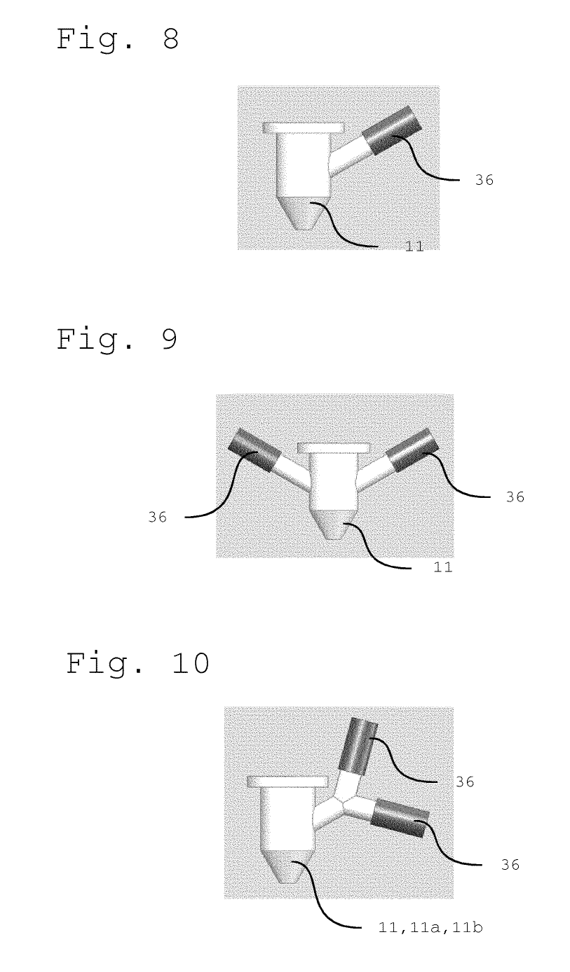

FIG. 12 shows a printer head 46 with three concrete printer nozzles 11, 11a, 11b and corresponding nozzle connections 36 next to each other. The arrangement allows for the simultaneous operation of supporting concrete nozzles 11 a and liquid concrete nozzles 11b through a corresponding positioning. This makes the structure of concrete finished parts run faster in parallel operation of the concrete printer nozzles 11a, 11b. The arrangement of the concrete printer nozzles 11a, 11b can be designed parallel, crossways or diagonal to the alignment of the cross beam 9. Through a rotating unit 45 shown in FIG. 4, the alignment of the concrete printer nozzles 11a, 11b can be changed to each other corresponding to the requirements.

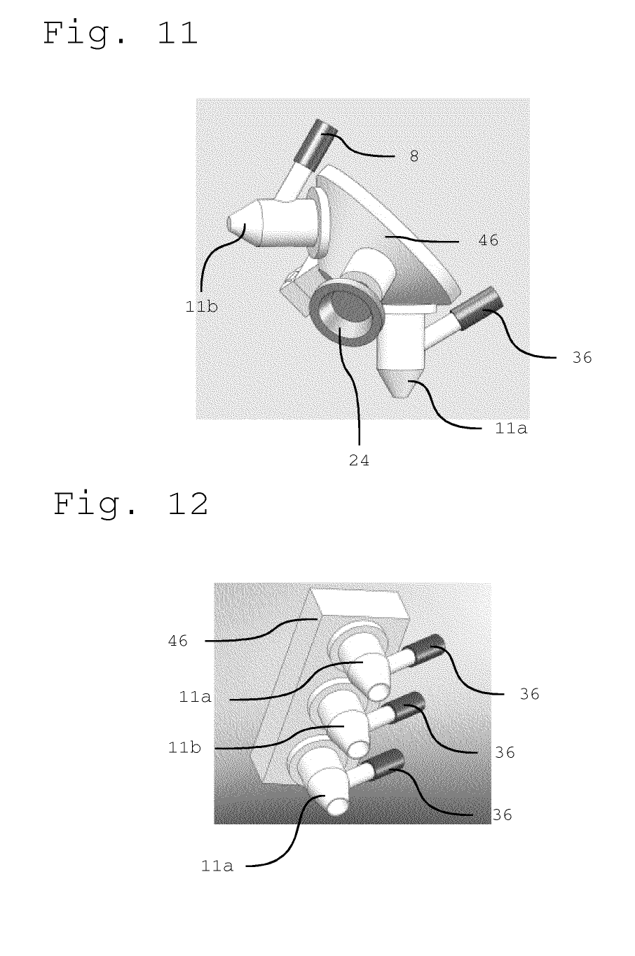

Finally, the concrete printer nozzles 11a, 11b can be arranged as desired in a ring-shape as shown in the example in FIG. 13.

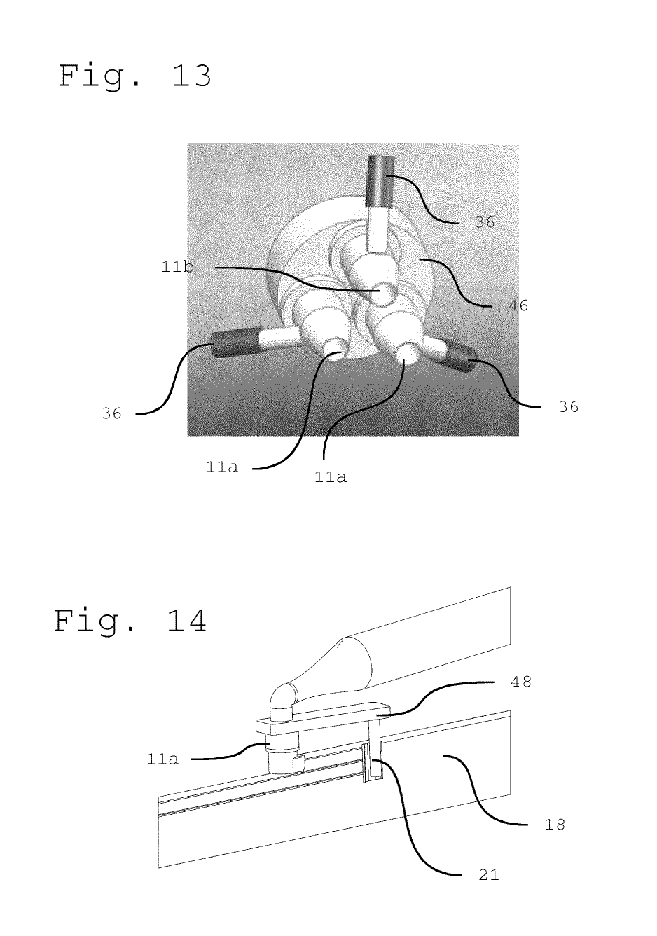

FIG. 14 shows a support concrete nozzle 11a on which a smoothing unit 21 is mounted as a float 21 through a holder 48. The float 21 is there to apply the external concrete layer 18 from the applied concrete 18 and therefore to smooth the surface of the created supporting concrete 18 directly after applying concrete 18. The float 21 may also be designed as a rotating float 21 as shown in FIG. 15.

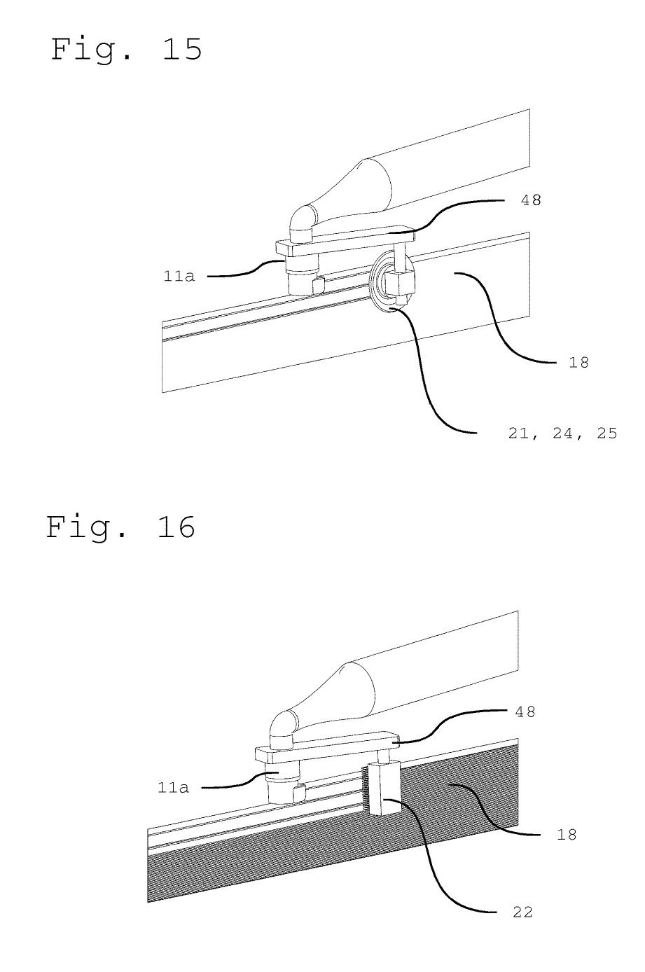

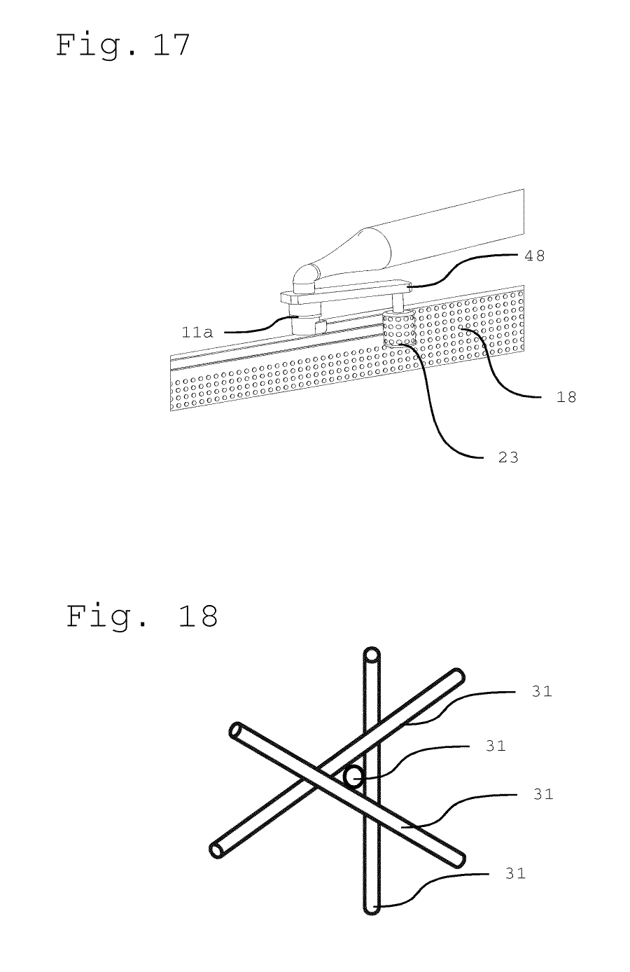

Instead of the float 21, a bursting unit 22 shown in FIG. 16 or an embossing roller 23 shown in FIG. 17 for surface treatment of the external concrete layer 18 of the created construction element may be aligned.

Thus, the surface treatment of the external concrete layer 18 may occur in a wet state directly after application of the supporting concrete 18.

FIG. 18 shows an example arrangement of reinforcer bars 31 in a view from above. The three crossing reinforcer bars 31 can therefore hold a reinforcer bar 31 arranged vertically in the middle (shown as a circle). The crossing reinforcer bars 31 are embedded at the ends, for example, in supporting concrete (not illustrated). Alternatively, the holding reinforcer bars 31 may also be bent or angled.

FIG. 19 shows an arrangement for holding a vertical reinforcer bar 31 through two retaining elements 42.

The retaining elements 42 are designed as discs here and are equipped with an opening in the middle through which the vertical reinforcer bar 31 is to be held. The discs from the retaining elements 42 are broken in the middle so that the liquid concrete (arrows) can flow through the retaining elements 42.

The wings of the retaining elements are embedded, for example, in supporting concrete (not illustrated).

For the holding of vertical reinforcer bars 31, perforated tape (not illustrated) may also be used, whereby the vertical reinforcer bars 31 may be placed through the openings of the perforated tape if necessary. The perforated tape in turn is embedded in the supporting concrete (not illustrated).

The placement of the retaining elements 42, the perforated tape and the reinforcer bars 31 is carried out preferably with the reinforcement gripper 27 from the concrete printer. The concrete 18, 19 that has not been completely attached through the smoothing unit 21, bursting unit 22, embosser roller 23, milling unit 24 and/or grinding unit 25 may be added to the concrete mixer unit 33 through a suction unit 49 and therefore used during the manufacturing process of the concrete 18, 19 in a type of recycling.

The suction unit 49 also serves to extract the grinding and milling dust as well as other particles that arise through the use of the milling unit 24 as well as the grinding unit 25.

### LIST OF REFERENCE NUMERALS

1—Track

2—Carriage

3—Vertical track

4—fourth drive unit

5—first drive unit

6—lift truck

7—longitudinal bar

8—guide track

9—cross beam

10—second drive unit

11—concrete printer nozzle

11 a—supporting concrete nozzle

11b—liquid concrete nozzle

12—third drive unit

13—work head

14—dummy element

15—junction

16—spindle drive

17—toothed belt drive, toothed belt

18—supporting concrete, external concrete layer, outer contour, inner contour

19—liquid concrete

20—form printer nozzle

21—smoothing unit, float

22—bursting unit

23—embosser roller

24—milling unit, milling head

25—grinding unit

26—welding unit, welding robot

27—reinforcement gripper, gripper

28—trimming unit

29—bending unit

30—transport unit

31—reinforcer bar, reinforcer steel, reinforcement basket

32—concrete pump

33—concrete mixing unit

34—storage container

35—work head intake

36—nozzle connection

41—control unit

42—retaining elements

43—vertical axis

44—multiple axis robot

45—rotating unit

46—printer head, turret printer head

47—space

48—holder

X—longitudinal direction, lengthwise

Y—cross direction, cross

Z—vertical direction, vertical, height change

1. A concrete printer, in particular for the production of concrete elements and constructions, whereby a vertical (Z) moving lift truck (6) is arranged on two vertical tracks (3) with a first drive unit (5), whereby the lift truck (6) is connected with a longitudinal beam (7) in a longitudinal direction (X) horizontally and the longitudinal beam (7) is connected with two guide rails (8) in a longitudinal direction (X), whereby a a cross beam (9) oriented at a right angle to the longitudinal beam (7) can be moved along the guide rail (8) with a second drive unit (10) and at least one moving work head (13) is arranged on a concrete printer nozzle (111) that can move along the cross beam (9) and moved through a third drive unit (12), whereby the control of the drive units (5, 10, 12) and the concrete printer nozzles (11, 11a, 11b) is realised through a control unit (41).

2. The concrete printer according to claim 1, characterised in
that the vertical tracks (3) are arranged on a carriage (2) whereby the carriage (2) preferably is arranged on a track (1) laid in a horizontal longitudinal direction (X) and can be moved through a fourth drive unit (4), whereby the control of the fourth drive unit (4) is realised through the control unit (41).

3. The concrete printer according to claim 1,
characterised in
that the longitudinal beam (7) and/or the cross beam (9) are designed as framework constructions, preferably as 3-belt or 4-belt framework constructions, whereby the framework constructions are preferably designed with dummy elements (15) made of fibre-reinforced plastics and with junctions (16) made of aluminium.

4. The concrete printer according to claim 1,
characterised in
that in particular the first, second and third drive units (5, 10, 12) are designed respectively as spindle drives (16) or toothed gear drives (17).

5. The concrete printer according to claim 1,
characterised in
that the work head (13) includes at least a supporting concrete nozzle (11a) to apply low-water supporting concrete (18) and at least a liquid concrete nozzle (11b) to apply water-saturated liquid concrete (19).

6. The concrete printer according to claim 1,
characterised in
that the concrete printing nozzles (11a, 11b) are equipped with one, two or multiple individual and/or grouped controllable nozzle connections (36) and therefore formed as mixed nozzles and/or switch nozzles.

7. The concrete printer according to claim 1
characterised in
that the work head (!3) has at least a form printing nozzle (2), a smoothing unit (21), a bursting unit (22), an embossing roller (23), a milling unit (24), a grinding unit (25), a welding unit (26), a reinforcement gripper (27) and/or a suction unit (49).

8. The concrete printer according to claim 1,
characterised in
that the concrete printing nozzles (11a, 11b), the form printing nozzle (20), the smoothing unit (21), the bursting unit (22), the embossing roller (23), the milling unit (24), the grinding unit (25), the welding unit (26) and/or the reinforcement gripper (27) are arranged individually or combined with each other respectively on different work heads (13).

9. The concrete printer according to claim 1,
characterised in
that the concrete printer has a trimming unit (28), a bending unit (29) and/or a transport unit for reinforcer bars (31).

10. The concrete printer according to claim 1,
characterised in
that the concrete printer, preferably on the carriage (2), has at least a concrete pump (32) and/or at least a concrete mixing unit (33) and/or at least a storage container (34) for concrete and/or concrete additives.

11. The concrete printer according to claim 1,
characterised in
that the work head (13) in a work head intake (35) can be rotated at least by a vertical axis (43) through a rotating unit (45).

12. The concrete printer according to claim 1,
characterised in
that the work head (13) or aggregates from the work head (13) are designed as multiple axis robots (44).

13. The concrete printer according to claim 7,
characterised in
that the form nozzles (21) are at least arranged horizontally on the work head (13).

14. A method for creating concrete elements and constructions using a concrete printer according to claim 1,
characterised in
that initially supporting concrete (18) from a supporting concrete nozzle (11a) is initially cast or applied for an outer contour (18) and/or inner contour (18), then optionally reinforcing bars (31) are inserted and then the spaces (47) between the supporting concrete sections (18) and reinforcing bars (31) are cast with liquid concrete (19) from the liquid concrete nozzle (11b).

15. The method for creating constructions according to claim 14,
characterised in
that the concrete printer prints retaining elements (42) next to or with the outer contour (18) and/or inner contour (18) and/or that retaining elements (42) are installed through the gripper (27), then reinforcer bars (31) are placed in the retaining elements and the liquid concrete is printed from the concrete printing nozzles (11, 11a, 11b).

16. The method for creating constructions according to claim 14,
characterised in
that the sequence of the production of the outer contour (18) and/or inner contour (19), the production or placement of retaining elements (42), the arrangement of the reinforcer bars (31) and the application of liquid concrete (19) is repeated in layers.

17. The method for creating constructions using a concrete printer according to claim 1,
characterised in
that supporting concrete (18) will be applied around a basket with reinforced bars (31) through a supporting concrete nozzle (11a) and hereafter the spaces (47) between the supporting concrete sections (18) will be cast with liquid concrete (19) from the liquid concrete nozzle (11b).

18. The method for creating constructions according to claim 14,
characterised in
that the respective reinforcement reinforcing bar (31) are cut to the required length in the trimming unit (28), bent to the defined form in the bending unit (29), moved to the required position with the transport unit (30) and the reinforcement gripper (27) and/or the reinforcing bars (31) are welded together through the welding unit (26).

19. The method for creating constructions according to claim 14,
characterised in
that a form is created for the supporting concrete (18) and/or liquids (19) through the form nozzle (20).

20. The method for creating constructions according to claim 14,
characterised in
that a surface treatment of the external concrete layer occurs through a smoothing unit (21), bursting unit (22), embossing roller (23), milling unit (24) and/or grinding unit (25) parallel to the application of the concrete (18, 19) and/or directly following this.

21. The method for creating constructions using a concrete printer according to claim 1,
characterised in
that initially supporting concrete (18) from a supporting concrete nozzle (11a) is initially cast or applied for an outer contour (18) and/or inner contour (18), then optionally reinforcing bars (31) are inserted and then the spaces (47) between the supporting concrete sections (18) and reinforcing bars (31) are cast with liquid concrete (19) from the liquid concrete nozzle (11b).
